(19) United States
(12) Patent Application Publication
(10) Pub. No.: US 2008/0319902 A1
(43) Pub. Date: Dec. 25, 2008

(54) Method and Apparatus for Facilitating a Secure Transaction

(76) Inventors: Mark Mervyn Chazan, New South Wales (AU); Alexander Grinberg, New South Wales (AU); Michael Kontorovich, New South Wales (AU); Colin Reyburn, New South Wales (AU)

Correspondence Address: LADAS & PARRY LLP, 224 SOUTH MICHIGAN AVENUE, SUITE 1600, CHICAGO, IL, 60604, US

(21) Appl. No.: 12/094,177

(22) PCT Filed: Nov. 17, 2006
(86) PCT No.: PCT/AU2006/001713

§ 371 Date: Aug. 14, 2008

(30) Foreign Application Priority Data
Nov. 18, 2005 (AU) 2005906413

(51) Int. Cl. G06Q 40/00; H04L 9/32; G06Q 20/00

(52) U.S. Cl. 705/42; 726/6; 705/44

(57) ABSTRACT

A method and apparatus for facilitating a secure transaction via a computer network. It is known for fraudsters to carry out “man-in-the-middle” attacks utilizing malicious software which diverts communications or corrupts communication between users and a financial institution computer, in order for the fraudster to modify the transaction. A secure object is generated which includes a security identifier and a transaction identifier. In an embodiment, the secure object is an image, and the secure identifier can not be detected by the man-in-the-middle computer. The transaction only proceeds when user enters the secure identifier.

### FIELD OF THE INVENTION

The present invention relates to a method and apparatus for facilitating a secure transaction via a computer network, and, particularly, but not exclusively, to a method and apparatus for facilitating a financial transaction via a network such as the Internet.

### BACKGROUND OF THE INVENTION

Fraudulent interference with financial transactions which take place via computer networks is a well known and a significant problem. Financial institutions that operate systems which enable transactions over computing networks, such as Internet banking sites, use a number of security arrangements to combat fraud.

The most common security arrangements often require the user to input identification codes, such as passwords, that identify the user to the banking system. Such security arrangements still allow for fraud if the fraudster can obtain the identification code details.

To a certain extent such fraudulent approaches can be combated by security arrangements such as Two Factor Authentication solutions using hardware tokens, and also by the user being “watchful” and, for example, not answering fraudulent emails which request the user's security details (e.g. “Phishing” approaches).

No amount of “watchfulness” on the part of the user, nor any presently available Two Factor authentication solution, is able to protect against “Man-in-the-Middle” attacks. In a Man-in-the-Middle attack, maliciously installed software (on a user's computer) establishes an initial connection between the user's computer and a malicious computing apparatus which provides to the users computer what appears to be a connection to a genuine financial institution (e.g. web pages that appear to be a genuine Internet banking site, but are not). The user is unaware they are not connected to the correct site. The malicious software “watches” for the user to enter the usual Internet address for their financial institution and then re-directs the user's computer to the fraudulent bank site.

In real time, the connected malicious computing apparatus makes a connection to the real bank site, using security identification code(s) obtained from the user. The malicious computer apparatus fools both the client (user) and the server (serving the financial institution pages) into believing that they are communicating with one another, when, in fact, the fraudster is intercepting all traffic between the parties. The attacker now has a fully working session and has the possibility of either modifying the user's transactions and/or carrying out his own transactions.

There are also other techniques used by fraudsters which have similar effects to Man-in-the-Middle attacks. For example, malicious software may modify details of a transaction (e.g. payee, value) without a customer or bank being aware. Payment is then made to an unauthorised third party.

Other difficult to detect problems include malicious software modifying the hosts file, malicious keyboard logger software, malicious keyboard logger hardware, malicious wireless keyboard sniffers and malicious package sniffer software. All are difficult to detect and all may enable a user's secure identification details to be stolen.

### SUMMARY OF THE INVENTION

In accordance with a first aspect, the present invention provides a method of facilitating a secure transaction via a computer network, comprising the steps of generating a secure object which includes a transaction identifier and a security identifier, the secure object not being machine readable to identify the security identifier, and requiring a user to identify the security identifier from the object and input the security identifier to enable the transaction to proceed.

In an embodiment, the transaction identifier and security identifier are combined in the secure object in such a way that it is not possible to machine extract one from the other and retain the security identifier intact. A human user can, however, identify the security identifier and transaction identifier.

Because the secure object is not machine readable to extract the security identifier, this, in at least one embodiment, has the advantage that a Man-in-the-Middle computer apparatus is unable to identify the security identifier. Without the security identifier being returned (e.g. to a financial institution system) the transaction will not be allowed to proceed. It is not feasible for Man-in-the-Middle attacks to practically, in real time, employ people sitting at computers to identify the security identifier.

It may be possible that, given enough time and suitable technology, a machine, such as a computer apparatus may be able to extract the security identifier from the secure code. This will be extremely difficult and is likely to take much longer than the usual transaction process between a user and a financial institution so that it would be too difficult to extract the secure ID and then still proceed with a fraudulent transaction. The term “the secure object not being machine readable” should be interpreted to cover the situation where it may be machine readable, but not in time accurately enough to enable a fraudster to carry out the fraudulent transaction. Most financial institutions sites, for example, will “time out” if action is not taken to enter data within a predetermined time. In an embodiment of the present invention, the predetermined time may be set to ensure that there is not sufficient time for a machine to extract the security identifier from the secure code and input it to enable the transaction.

In an embodiment, “not being machine readable” means not being readable by a computer or software associated with a computer.

In an embodiment, a Man-in-the-Middle or other interposed computing system or software cannot remove the transaction identifier (which for example may be an account number that the user wishes to pay) and replace with a false transaction identifier, as the user will not confirm the transaction unless he identifies a transaction identifier that he provided in the first place. In an embodiment a Man-in-the-Middle or other interposed computing system or software cannot provide the financial institution with a false transaction ID and the user with the ID required by the user, without affecting the secure object.

In an embodiment, the secure object comprises an image, and may be an overlay image in which the transaction identifier and the security identifier are overlayed.

In an embodiment, a security identifier and transaction identifier may be placed at different angles to each other. In an embodiment, each time a secure object is generated, the angles may be varied. In an embodiment, the secure object is dynamically created. That is, it is generated each time transactions security is required. Storing the security identifier as an image on a web server, for example, would compromised security. Generating the image data dynamically avoids this potential problem. In an embodiment, the secure object is dynamically streamed to the client.

In an embodiment, the transaction identifier comprises an account number of a payee.

In alternative embodiments, the transaction identifier need not be an account number of a payee, but may be any identifier that identifies to the user that the transaction is a valid one.

In an embodiment, the secure object also comprises a payment amount, representing an amount to be paid from a user account.

In an embodiment, the secure object comprises a sound file.

In order to provide further protection, in an embodiment, transmissions over a network including secure data, such as transaction confirmation data, are sent using encryption.

In accordance with a second aspect, the present invention provides a system for facilitating a secure transaction via a computer network, the system comprising a secure object generator for generating a secure object which includes a transaction identifier and a security identifier, the secure object not being machine readable to extract the security identifier, and a receiver arranged to receive an input from a user who has identified the security identifier from the object, and to determine whether the input includes the security identifier, whereby to enable the transaction to proceed.

In accordance with a third aspect, the present invention provides a computing apparatus arranged to generate a secure object which comprises a transaction identifier and a security identifier, the secure object not being machine readable to identify the security identifier, the secure object being usable to facilitate a secure transaction.

In accordance with a fourth aspect, the present invention provides a computer programme including instructions for controlling a computing apparatus to implement a method in accordance with the first aspect of the present invention.

In accordance with a fifth aspect, the present invention provides a computer readable medium providing a computer programme in accordance with the fourth aspect.

In accordance with a sixth aspect, the present invention provides a computer programme including instructions for controlling a computing apparatus to implement a system in accordance with the second aspect of the present invention.

In accordance with a seventh aspect, the present invention provides computer readable medium providing a computer programme in accordance with the sixth aspect of the present invention.

In accordance with an eighth aspect, the present invention provides a method of facilitating a secure transaction via a computer network, including the steps of generating a security identifier, the security identifier not being machine readable, and requiring the user to identify the security identifier and input the security identifier to enable the transaction to proceed.

In accordance with a ninth aspect, the present invention provides a system for facilitating a secure transaction via a computer network, the system comprising a secure identifier generator, for generating a security identifier, the security identifier not being machine readable, and a receiver arranged to receive an input from a user who has identified the security identifier and to determine whether the input includes a security identifier, whereby to enable the transaction to proceed.

In one embodiment, the security identifier is associated with a transaction identifier. In one embodiment the security identifier is associated with the transaction identifier is such a way that both must be provided to the user so that the user can confirm the correct transaction identifier before inputting the security identifier.

In accordance with a tenth aspect, the present invention provides a computer program comprising instructions for controlling a computer to implement a method in accordance with the eighth aspect of the invention.

In accordance with an eleventh aspect, the present invention provides a computer readable medium providing a computer program in accordance with the tenth aspect of the invention.

In accordance with an twelfth aspect, the present invention provides a method of facilitating a secure transaction via a computer network, comprising the steps of generating a secure object which includes a transaction identifier, the secure object comprising an image comprising the security identifier and further material which is merged with the image, and requiring the user to identify the security identifier from the object and input the security identifier to enable the transaction to proceed.

In an embodiment, the further material is a transaction identifier.

In accordance with a thirteenth aspect, the present invention provides a system for facilitating a secure transaction via a computer network, the system comprising a secure object generator for generating a secure object which includes a transaction identifier, the secure object comprising an image comprising the security identifier and further material which is merged with the image, and a receiver arranged to receive an input from a user who has identified the security identifier from the object, and to determine whether the input includes the security identifier, whereby to enable the transaction to proceed.

In accordance with a fourteenth aspect, the present invention provides a computer program comprising instructions for controlling a computer to implement a method in accordance with the twelfth aspect of the invention.

In accordance with a fifteenth aspect, the present invention provides a computer readable medium providing a computer program in accordance with the fourteenth aspect of the invention.

In accordance with a sixteenth aspect, the present invention provides a method of facilitating a secure transaction via a computer network, comprising the steps of generating a secure object which includes a transaction identifier, the secure object being generated as an audio file, and requiring the user to identify the security identifier from the object and input the security identifier to enable the transaction to proceed.

In an embodiment, the secure object also includes a transaction identifier.

In accordance with a seventeenth aspect, the present invention provides a system for facilitating a secure transaction via a computer network, the system comprising a secure object generator for generating a secure object which includes a transaction identifier, the secure object being generated as an audio file, and a receiver arranged to receive an input from a user who has identified the security identifier from the object, and to determine whether the input includes the security identifier, whereby to enable the transaction to proceed.

In accordance with an eighteenth aspect, the present invention provides a computer program comprising instructions for controlling a computer to implement a method in accordance with the sixteenth aspect of the invention.

In accordance with a nineteenth aspect, the present invention provides a computer readable medium providing a computer program in accordance with the eighteenth aspect of the invention.

In accordance with a twentieth aspect, the present invention provides a secure object which includes a transaction identifier and a security identifier, the secure object not being machine readable to extract the security identifier, the secure object being usable to facilitate a secure transaction.

### BRIEF DESCRIPTION OF THE DRAWINGS

Features and advantages of the present invention will become apparent from the following description of an embodiment thereof, by way of example only, with reference to the accompanying drawings, in which:

FIG. 1 is a schematic diagram illustrating a “Man-in-the-Middle” type attack;

FIG. 2 is a diagram illustrating operation of a method in accordance with an embodiment of the present invention;

FIG. 3 is a representation of a computer screen which may be generated in accordance with an embodiment of the present invention;

FIG. 4 is flow diagram illustrating operation of an embodiment of the present invention; and

FIG. 5 is a representation of a computer screen which may be generated in accordance with an alternative embodiment of the present invention.

### DETAILED DESCRIPTION OF PREFERRED EMBODIMENT

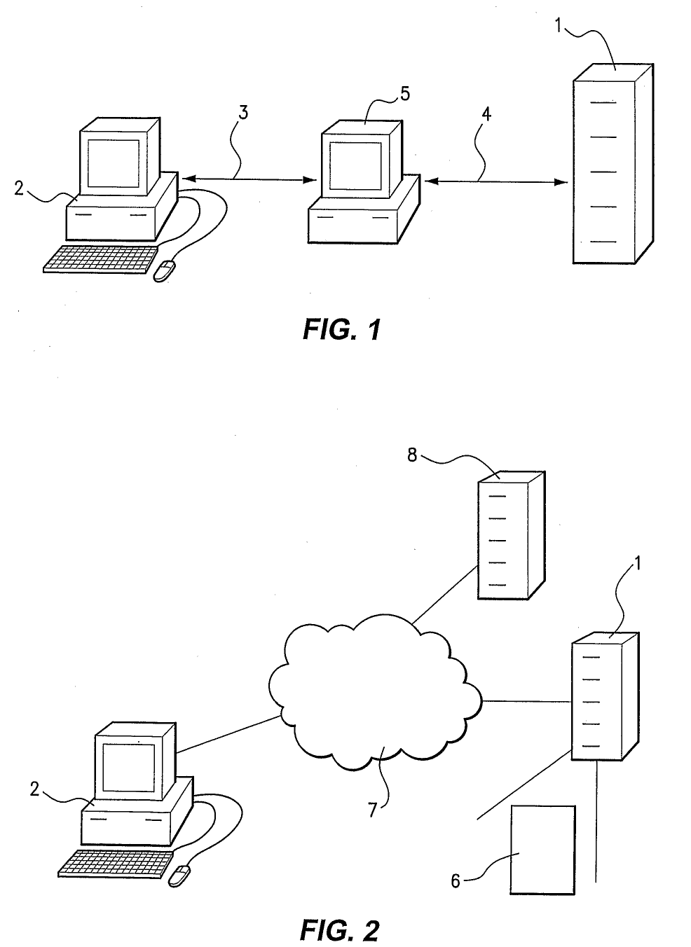

FIG. 1 illustrates a type of fraudulent attack known as a “Man-in-the-Middle” attack. Server 1 is, in this example, operated by a financial institution and is arranged to serve web pages (not shown) to the Internet to facilitate Internet banking, as is known. A user computer 2, is operated by a user to access the Internet banking facility provided by server computer 1. In the normal course of events, the user computer 2 accesses the server computer 1 via a network such as the Internet and undertakes transactions, such as transfer of funds from a user account to a payee account. Note that in this diagram the network connections are illustrated by arrows 3 and 4. Connection may be by way of any network infrastructure and for the purposes of this example connection is via the Internet.

In FIG. 1, it can be seen that a Man-in-the-Middle attack has occurred and a further computer 5 (which will be termed a “Malicious Computer”) has interposed itself between the user computer 2 and server 1. This can be carried out in a number of ways, but in this example, malicious software (e.g. a Trojan) resident on the user computer 2 detects when the user enters an IP address corresponding to the server 1 and automatically re-directs the user computer 2 to the malicious computer 5 without the user being aware.

The malicious computer 5 then presents the user computer 2 with what looks like a “real” web page which would be provided by the server computer 1. This fraudulent web page requests user access means from the user computer 2 e.g. log in code and password. The user provides this as they have no way of knowing that the “site” they are connected to is not the genuine site provided by the financial institution server 1. The malicious computer 5 then takes this access information and logs into the genuine site via connection 4. All this may be done in real time. Neither the user nor the financial institution are aware that the attack is taking place. The malicious computer 5 can now carry out any transaction that it is able to with the user's access details. For example, it could instruct payment into an account of a fraudster.

The malicious computer 5 can present to the user computer 2 any misleading information that it may wish to. It may, for example, merely present an “error” message once it has obtained the user access details. Alternatively, it could even pass back statement information from the server computer 1, or even make it look like the transaction that the user desires is taking place. Neither the user nor the financial institution may therefore know for some time that fraudulent transactions are being carried out.

An embodiment of the present invention will now be described with references to FIGS. 2, 3 and 4.

In this embodiment, before a transaction is allowed to proceed, a secure object is generated which includes a security identifier, as well as a transaction identifier. A user must identify the security identifier from the secure object and confirm the transaction by providing the security identifier back to, for example, a server computer operated by a financial institution. In this embodiment, the user will also identify the transaction identifier before they input the security identifier. Referring to FIG. 2, server computer 1, operated by a financial institution, such as a bank, serves web pages 6 over the Internet 7. The web pages 6 represent a website where financial transactions are able to be instructed, for example, an Internet banking site.

User computer 2 is able to access the web pages 6 over the Internet 7 in order to carry out transactions from a user account.

A secure object generator computing system (in the form of a server computer) 8 is arranged to generate secure objects on request from server computer 1. The secure object is provided to the user computer 2. If the user requires a financial transaction e.g. transaction to send funds from a user account to a payee account, the transaction will not proceed until the user confirms, via the user computer 2, the transaction by entering the security ID identified by the user from the secure object.

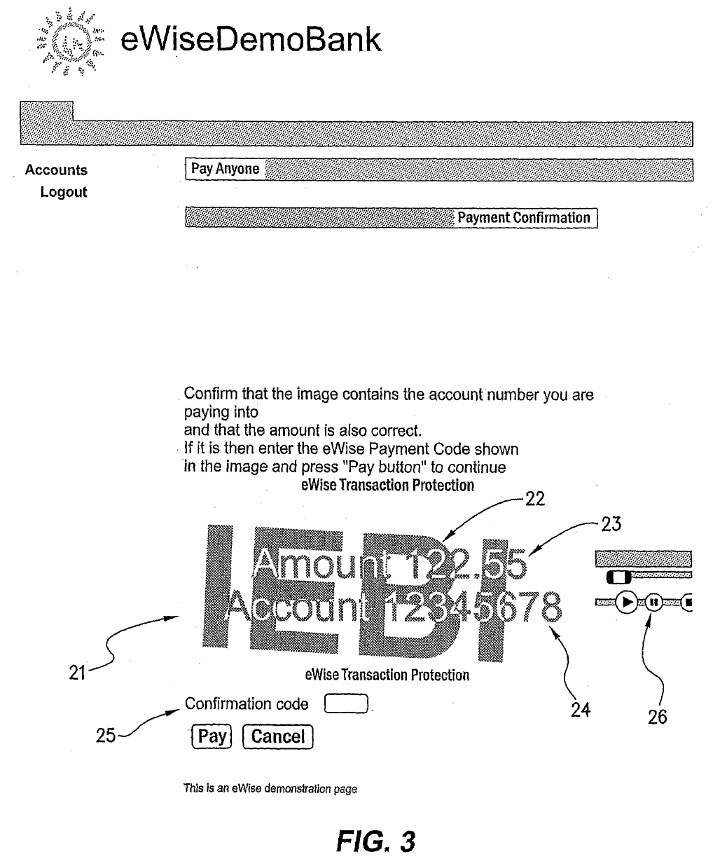

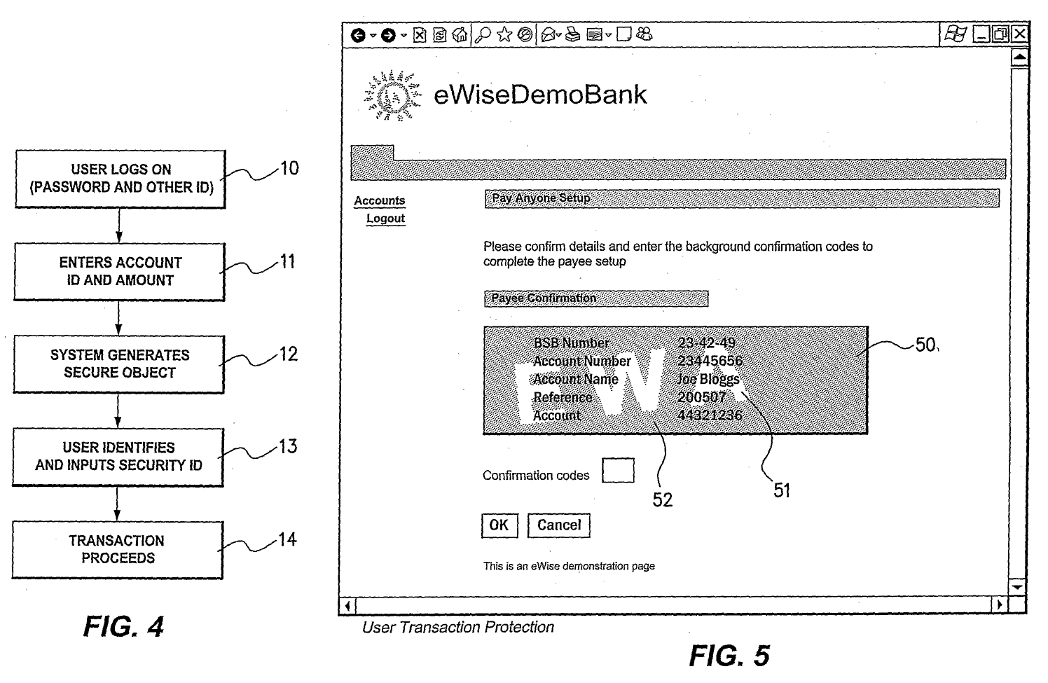

In more detail and referring to FIG. 3 and FIG. 4, at step 10 (FIG. 4), the user logs on from computer 2 at website 6 and enters their password and any other ID that may be required by the financial institution for them to enter a site which, for example, shows user account information and enables the user to make transactions.

The user may wish to transfer money to a payee, and they enter the payees account identifier and an amount of funds to be transferred (step 11).

In this embodiment, the server computer 1 then requests from the secure object generator computer 8 a secure object (step 12). In this embodiment, the secure object is dynamically streamed over the Internet 7 to the user computer 2.

Streaming the secure object has an advantage of providing further security. Retaining the secure object on a financial institution server, for example, would be a security risk.

Referring to FIG. 3, a screen which may appear on the user computer 2 following generation of the secure object is shown. The screen includes a representation 21 of the secure object. In this embodiment, the secure object is an overlay image which includes the security ID 22 (in this embodiment being a text code “1EB1”) the amount 23 of the payment and the account 24 to be paid. These are all provided in an overlay image which cannot accurately be machine read to identify the security ID (with this type of overlay image it is difficult for a machine to identify any of the information which is included in the overlay). Any Man-in-the Middle type malicious computer would therefore be unable to read or otherwise identify the security ID.

Note that where trademarks and brands are used in FIG. 3 (such as eWise), these are in no way limiting to the present invention and only representative of how an actual web page may look in operation.

The user then identifies the secure ID 22 and inputs it as the confirmation code 25 (step 13). The financial institution computer 1 then allows the transaction to proceed (step 14).

Because the financial institution requires the security ID before it will proceed with the transaction, a Man-in-the-Middle attack cannot succeed (as the malicious computer cannot identify the security ID). Further, the transaction ID cannot be extracted from the secure ID so there is no possibility of the malicious computer being able to provide the correct account details to the user computer and incorrect account details to the financial institution computer. In this embodiment, the image cannot be “unscrambled” by the malicious computer to enable this.

This embodiment guards against similar attacks, such as malicious software on a user computer operating to change account details input by a user in real time.

From FIG. 3, it can be seen that the security ID 22 is at an angle to the amount 23 and account 24 details. In an embodiment, each time a secure object is generated, different angles are randomly assigned.

FIG. 5 shows an alternative way that a secure object may be generated. The secure object 50 in FIG. 5 includes detailed account information 51 overlaying an image 52. The account information 51 includes BSB number, account number, account name, reference and account (to be paid from).

As an added security feature, communications between the user computer and financial server can be encrypted with, for example, SSL type encryption.

Other secure objects than a generated image can be used. For example, an audio file could be used to include the account and the security identifier. An audio file icon is illustrated in FIG. 3 and identified by reference numeral 26. The audio file includes (in audio) the security identifier and transaction identifier, and the audio file will need to be played to a user to enable the user to identify the security identifier (and also confirm that the transaction identifier is for the correct transaction).

An audio file may be used in combination with an image, for ease of use, including vision impaired users. Secure objects may be used separately or together in any combination for additional security.

In the above-described embodiment, the secure object is generated by a separate computing apparatus (reference numeral 8 in FIG. 2). This need not be the case, and the secure object could be generated by the financial institution server computer 1. Any available and convenient architecture may be utilised.

In the above embodiment, the secure object has been used to facilitate a financial transaction. The present invention is not limited to financial transactions and a similar arrangement could be used to facilitate other types of transactions.

The secure object can be anything that is capable of being received and processed by a user or indeed by a device in the users possession, and which cannot easily be machine read to identify the security ID. It may include, sound, an image, a movie clip, etc.

As discussed above, the transaction ID may be an account identifier but is not limited to this. It can be any code identifying any transaction that the user wishes to take place, not limited to a financial transaction. It can be any code that the user can use to confirm that the correct transaction is taking place.

It will be appreciated that, where elements of the present invention are implemented by computing apparatus, any appropriate computer hardware/software architecture may be utilised that implements the functionality as described above.

It may be possible that, given enough time and suitable technology, a machine, such as a computer apparatus may be able to extract the security identifier from the secure code. This will be extremely difficult, however. In particular, it is likely to take much longer than the usual transaction process between a user and a financial institution so that it would be too difficult to extract the secure ID and then still proceed with a fraudulent transaction. The term “the secure object not being machine readable” should be interpreted to cover the situation where it may be machine readable, but not in time accurately enough to enable any profit to a fraudster (e.g. to enable a fraudster to carry out any fraudulent transaction).

In the above-described embodiment, the computer network is the Internet. The present invention is not limited to operation over the Internet, but may operate over any computer network.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A method of facilitating a secure transaction via a computer network, comprising the steps of generating a secure object which includes a transaction identifier and a security identifier, the secure object not being machine readable to identify the security identifier from the object and input the security identifier to enable the transaction to proceed.

2. A method in accordance with claim 1, wherein the transaction identifier and security identifier are combined in the secure object in such a way that it is not possible to machine extract one from the other and return the security identifier intact.

3. A method in accordance with claim 1, wherein the security object comprises an image which combines the transaction identifier and security identifier.

4. A method in accordance with claim 3, wherein the image comprises an overlay image wherein the transaction identifier and security identifier are overlaid.

5. A method in accordance with claim 4, wherein the transaction identifier and a security identifier are overlayed at an angle to each other.

6. A method in accordance with claim 5, wherein each time a secure object is provided the angel is randomly generated.

7. A method in accordance with claim 1, wherein the security object comprises a sound file.

8. A method in accordance with claim 1, wherein the transaction comprises a financial transaction.

9. A method in accordance with claim 8, wherein the transaction identifier comprises the identity of an account which a user wishes to make a financial transaction to.

10. A method in accordance with claim 8, wherein the computer network is the Internet, and the secure object is generated by an Internet transaction facility.

11. A method in accordance with claim 8, wherein the Internet transaction facility is an Internet banking facility.

12. A method in accordance with claim 10, wherein the secure object is generated by a secure object generator computing system.

13. A method in accordance with claim 1, wherein the secure object is dynamically created.

14. A system for facilitating a secure transaction via a computer network, the system comprising a secure object generator for generating a secure object which includes a transaction identifier and a security identifier, the secure object not being machine readable to extract the security identifier, and a receiver arranged to receive an input from a user who has identified the security identifier form the object, and to determine whether the input includes the security identifier, whereby to enable the transaction to proceed.

15. A system in accordance with claim 14, wherein the transaction identifier and security identifier are combined in the secure object in such a way that it is not possible to machine extract one from the other and return the identifier intact.

16. A system in accordance with claim 14, wherein the secure object is an image which combines the transaction identifier and security identifier.

17. A system in accordance with claim 16, wherein the image is an overlay image, wherein the transaction identifier and security identifier are overlayed.

18. A system in accordance with claim 14, wherein the secure object is a sound file.

19. A system in accordance with claim 14, wherein the transaction is a financial transaction.

20. A system in accordance with claim 19, wherein the transaction identifier is the identity of an account which a user wisher to make financial transaction to.

21. A system in accordance with claim 14, wherein the computer network is the internet, and the means for generating the secure object is provided by an internet transaction.

22. A system in accordance with claim 21, wherein the internet transaction facility is an internet banking facility.

23. A computing apparatus arranged to generate a secure object which comprises a financial transaction identifier and a security identifier, the secure object not being machine readable to extract the security identifier, the secure object being usable to facilitate a secure financial transaction.

24. A computer programme including instructions for controlling a computer apparatus to implement a method in accordance with claim 1.

25. A computer readable medium providing a computer programme in accordance with claim 24.

26. A method of facilitating a secure financial transaction via a computer network, comprising the steps of generating a security identifier, the security identifier not being machine readable, and requiring the user to identify the security identifier and input the security identifier to enable the transaction to proceed.

27-38. (canceled)
